(19) United States
(12) Patent Application Publication
(10) Pub. No.: US 2013/0204409 A1
(43) Pub. Date: Aug. 8, 2013

(54) BUILDING MANAGEMENT SERVER AND BUILDING ILLUMINATION CONTROL METHOD

(71) Applicant: SK Telecom Co., Ltd., Seoul (KR)

(72) Inventor: Tae Jin SHIN, Seoul (KR)

(73) Assignee: SK TELECOM CO., LTD., Seoul (KR)

(21) Appl. No.: 13/786,547

(22) Filed: Mar. 6, 2013

Related U.S. Application Data
(63) Continuation of application No. PCT/KR2011/004964, filed on Jul. 7, 2011.

(30) Foreign Application Priority Data
Sep. 6, 2010 (KR) 10-2010-0087116

(51) Int. Cl. G05D 25/00

(52) U.S. Cl. CPC G05D 25/00
USPC 700/90

(57) ABSTRACT

The disclosure relates to automatically controlling illumination in a building, by recognizing a user ID, detecting the entry into and exit from a building by checking the recognized user ID, checking an illumination list in association with the user ID, and controlling one or more lights in the illumination list.

### CROSS-REFERENCE TO RELATED APPLICATION

The present application is a continuation of International Application No. PCT/KR2011/004964 filed on Jul. 7, 2011, which is based on, and claims priority from KR Application Serial Number 10-2010-0087116 filed on Sep. 6, 2010. The disclosures of the above-listed applications are hereby incorporated by reference herein in their entirety.

### FIELD

The disclosure relates to illumination control and management technology in a building.

### BACKGROUND

There have been technologies for automatically controlling lights in a building by sensing surrounding brightness through various sensors. Other automatic building illumination control facilities are installed and operated in such a manner that lights are turned on/off through central control according to a set relay for each lighting circuit group installed in each floor of a building and schedule control and pattern control are automatically performed according to a CCMS.

The inventors have noted that, in accordance with the current technologies, lights in a building are turned on/off according to previously set schedule irrespective of presence or absence of a user in the building, and thus the lights may be turned on in a vacant space, resulting in energy waste. Furthermore, since there are many lighting switches in the building, the inventors have noted that it is difficult for a user in the building to check switches in a corresponding area and to turn off unused lights when exiting from the building, causing further energy waste.

### SUMMARY

In accordance with some embodiments, the building management server comprises an access information management unit and a building control unit. The access information management unit is configured to recognize at least one user ID and to output user information corresponding to the recognized at least one user ID. The building control unit configured to check the user information outputted by the access information management unit to detect an entry or exit of a user corresponding to the at least one user ID into or form a building, check an illumination list in association with the at least one user ID according to the detected entry or exit, and control one or more lights in the illumination list. The building management server further comprises a main lighting control unit configured to manage one or more lights in the building upon receiving a request from the building control unit.

In a method of providing supplementary services in accordance with some embodiments, the building management server recognizes at least one user ID, outputs user information corresponding to the recognized at least one user ID, checks the outputted user information to detecting an entry into or exit of a user corresponding to the at least one user ID into or from a building; checks an illumination list association with the at least user ID according to the detected entry or exit; and controls one or more lights in the illumination list.

### BRIEF DESCRIPTION OF THE DRAWINGS

FIG. 1 is a block diagram of a system for automatically controlling illumination in a building in accordance with at least one embodiment.

FIG. 2 is a block diagram of a configuration of a management server in accordance with at least one embodiment.

FIG. 3 is a data flow diagram of a method for automatically controlling illumination in a building in accordance with at least one embodiment.

FIGS. 4 and 5 are flow diagrams of a method for automatically controlling illumination in a building in accordance with at least one embodiment.

FIG. 6 is a flow diagram of a method for automatically controlling illumination when a user moves in accordance with at least one embodiment.

FIG. 7 a table of user access information on entry into or exit from a building in accordance with at least one embodiment.

FIG. 8 a view of a lighting circuit in accordance with at least one embodiment.

### DETAILED DESCRIPTION

Reference will now be made in detail to the various embodiments of this disclosure with reference to the accompanying drawings. In the following description of this disclosure, a detailed description of known functions and configurations incorporated herein will be omitted when it may obscure the subject matter of the disclosure. The same reference numbers will be used throughout this specification to refer to the same or like parts.

The phraseology and terminology used in the specification and the appended claims should not be interpreted as limited general or literal meanings. Rather, they should be interpreted according to the technical features of this disclosure based on the principle that the inventor can define terms appropriately to describe his embodiments in the best way. For example, the term “building” used herein may refer to any structure that is used or intended for supporting or sheltering continuous or temporary occupancy by one or more users. In some embodiments, a building is a part of a larger complex, such as one or more floors of a multi-story structure, or a section of a floor. Accordingly, embodiments and configurations shown in the drawings are exemplary and do not completely represent the technical spirit of various embodiments of this disclosure, and thus it is noted that there are various equivalents and modifications that can replace the embodiments and configuration.

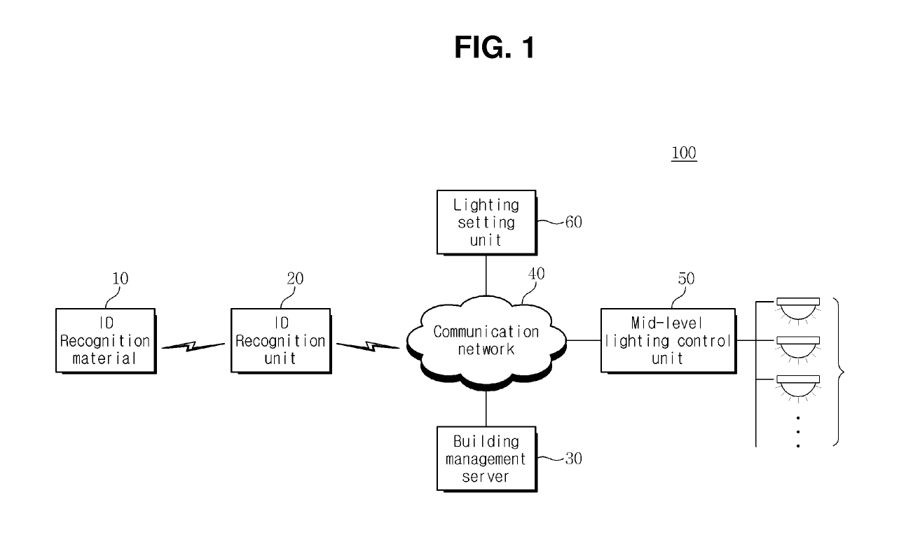

FIG. 1 is a block diagram of a system for automatically controlling illumination in a building in accordance with at least one embodiment.

Referring to FIG. 1, the system 100 (referred to as an automatic illumination control system, hereinafter) is configured to automatically controlling illumination in a building in accordance with at least one embodiment, and may include at least following elements such as an ID recognition material 10, an ID recognition unit 20, a building management server 30, a mid-level lighting control unit 50, a lighting setting unit 60, and a communication network 40.

The communication network 40 provides paths (or interfaces) for communication among the ID recognition unit 20, the mid-level lighting control unit 50, the lighting setting unit 60, and the building management server 30. The communication network 40 performs data transmission/reception operations for data transmission and information exchange among the ID recognition unit 20, the mid-level lighting control unit 50, the lighting setting unit 60 and the building management server 30. The communication network 40, which is an internet protocol (IP) network that provides a large-capacity data transmission/reception service and a seamless data service through IP, may be an all IP network corresponding to a combination of different networks based on IP. Alternatively, the communication network 40 may be one of a mobile communication network, wireless broadband (WiBro) network, high speed downlink packet access (HSDPA) network, satellite communication network, and a wireless LAN including Wi-Fi. Furthermore, the communication network 40 is connected by a cable to the ID recognition unit 20, the mid-level lighting control unit 50 and the building management server 30 through a wired communication network to provide data transmission/reception among the ID recognition unit 20, the mid-level lighting control unit 50 and the building management server 30.

The ID recognition material 10 is a means by which a user may be identified, and may be an object carried by the user or a portion of the body of the user. That is, the ID recognition material 10 may be an object, a portion of the user body or information, such as an RF card, fingerprint, iris, a number input using a keypad, etc. by which the user can be identified. The ID recognition material 10 in accordance with at least one embodiment is not limited to the above object or a portion of the user body and may include various types of information.

A plurality of ID recognition units 20 may be installed at entrances and exits of the building to recognize the ID of a user entering/exiting through the entrances and exits. The ID recognition unit 20 is configured to execute a function of recognizing a user ID through the ID recognition material 10. The ID recognition unit 20 can recognize the user ID through a recognition means such as RF card recognition, fingerprint recognition, iris recognition, number recognition using a keypad, etc. Each or group of the ID recognition units 20 is configured to transmit data about the user ID to the building management server 30. One or more ID recognition units 20 may be installed in each building, and a user ID recognized by the one or more ID recognition units 20 is transmitted to the building management server 30.

The building management server 30 is configured to manage facilities in the building, such as lighting devices, electronic devices, a network and so on. Particularly, the building management server 30 in accordance with at least one embodiment checks user information corresponding to a user ID recognized through the one or more ID recognition units 20, detects whether a user corresponding to the user ID enters the building, searches an illumination list in association with the user ID when the user enters the building, and controls lights included in the searched illumination list to be turned on.

Upon determining that the user corresponding to the checked user ID exits the building, the building management server 30 searches a illumination list in association with the user ID, checks whether the searched illumination list includes at least one light which may be associated with another user ID, and controls the rest of lights other than the at least one light associated with the another user ID to be turned off if the illumination list includes the at least one light associated with the another user ID.

The building management server 30 controls all the lights included in the illumination list to be turned off if the illumination list includes no lights associated with the another user ID.

The building management server 30 checks locations of offices involved with a plurality of users, searches a lighting circuit database (DB) for a plurality of illumination lists in association with routes (or paths) through which the users move from one spot (or one office) to another spot (or another office) in the building, matches user IDs of the users to the searched illumination lists and registers the matched illumination lists and user IDs in an user access DB.

The building management server 30 may control illumination in a remote building. In details, the building management server 30 can control a remote building that is not even equipped with an automatic illumination control system to control illumination in the remote building. Illumination in the remote building may be controlled through the mid-level lighting control unit 50 installed in each corresponding building. That is, the building management server 30 may check whether a recognized user ID corresponds to a user of a remote building, and perform data communication with the mid-level lighting control unit 50 of the remote building in order to control illumination of the remote building if the user ID corresponds to the user of the remote building. In this case, the building management server 30 checks whether the user enters the remote building, searches an illumination list in association with the user ID if the user enters the remote building, and controls at least one of lights included in the searched illumination list to be turned on.

The building management server 30 may calculate the number of people currently staying inside the building on the basis of user IDs, and store the calculated number at a memory or a storage equipped therein. Alternatively, the building management server 30 may check the number of people currently staying in the building by interworking with a so-called building heating ventilation and cooling system installed in the building. The number of people inside the building may be used to check people in the building at the event of fire outbreaks or crime occurrence in the building.

The building management server 30 checks whether a user requests an illumination list, provides a screen capable of and for selecting a plurality of lights when the user requests the illumination list, selects (or receives) the illumination list input by the user, checks (or analyzes and determines) whether the number of lights included in the illumination list exceeds a predetermined number, and finally sets the illumination list if the number of lights included in the illumination list does not exceed the predetermined number.

The building management servermanagement server 30 generates a warning message if the number of lights included in the illumination list exceeds the predetermined number.

The building management server 30 is configured to calculate power consumption of each light, to store power rates corresponding to the calculated power consumption for each floor and to display the power rates, in real time.

The mid-level lighting control unit 50 is included in each building and executes a switching function for lighting control of each building. The mid-level lighting control unit 50 turns lights on or off according to a lighting control signal received from the building management server 30.

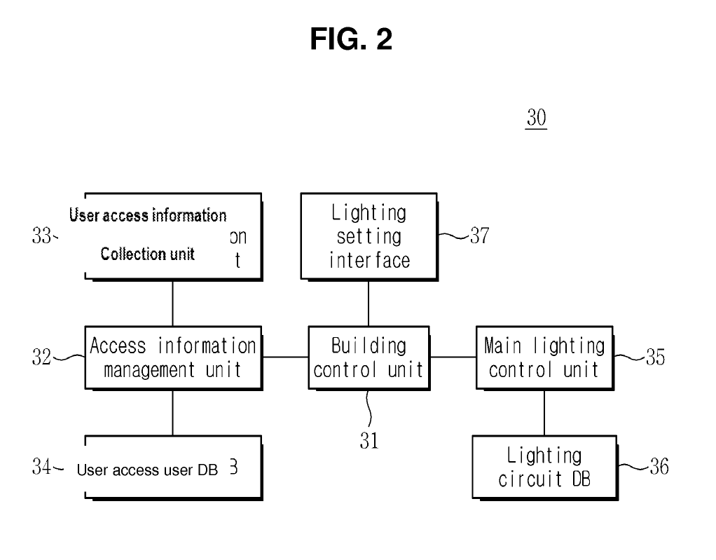

The lighting setting unit 60 is configured to provide a screen for setting an illumination list to the building management server 30 at the request of a user (or users). The lighting setting unit 60 may be connected to a web server to provide the screen for setting an illumination list to a lighting setting interface 37 of the building management server 30 shown in FIG. 2.

FIG. 2 is a block diagram of a configuration of the building management server 30 in accordance with at least one embodiment.

Referring to FIG. 2, the building management server 30 includes a building control unit 31, an access information management unit 32, an user access information collection unit 33, an user access DB 34, a main lighting control unit 35, the lighting setting interface 37, and a lighting circuit DB 36.

The access information management unit 32 is configured to manage entry into and exit from the building of at least one user. Here, the access information management unit 32 is configured to recognize (or check) a user ID transmitted from the user access information collection unit 33, search the user access DB 34 for user information corresponding to the recognized user ID and output (or extract) the user information. The user access DB 34 stores data about locations of offices of occupants (i.e., who currently staying) in the building. The user access information collection unit 33 is configured to collect information about a user ID (or a plurality of user IDs) recognized through the ID recognition unit 20 and to deliver the collected information to the access information management unit 32. The user access information collection unit 33 may collect data such as the ID of a newly registered user (or each ID of newly registered users), the location of the office of the newly registered user, and etc., and transmit the collected data to the access information management unit 32.

The main lighting control unit 35 is configured to manage all lights in the building at the request of the building control unit 31. The main lighting control unit 35 may search the lighting circuit DB 36 which stores locations of lights of each floor of the building and transmit data for lighting control to the mid-level lighting control unit 50. That is, the mid-level lighting control unit 50 is configured to control a plurality of lights according to a request signal of the main lighting control unit 35. The mid-level lighting control unit 50 may be configured to perform a switching function for controlling lights associated with an office corresponding to the user ID recognized through the ID recognition unit 20, from among the plurality of lights.

The building control unit 31 is configured to check user information corresponding to the user ID checked through the access information management unit 32 to detect an entry or exit of a user (or users) corresponding to the user ID. The building control unit 31 is also configured to determine whether the user (or users) corresponding to the user information enters into or exits from the building, to search an illumination list associated with the user ID (or each user ID of the users) when the user (or each of the users) enters into or exits from the building, and to instruct (or command) the main lighting control unit 35 to control lights included in the searched illumination list.

Upon determining that the user (or each user) corresponding to the user ID (or each user ID of the users) exits the building, the building control unit 31 is configured to search the illumination list associated with the user ID (or each user ID of the users), to check whether the illumination list includes at least one light which may be together included by another user ID, and to instruct the main lighting control unit 35 to control the rest of lights other than the at least one light together included by the another user ID if the illumination list includes the at least one light associated with the another user ID.

If the illumination list includes no light associated with the another user ID, the building control unit 31 instructs (or command) the main lighting control unit 35 to control all the lights included in the illumination list.

The building control unit 31 is configured to check locations of offices of a plurality of users, to search the lighting circuit DB 36 for a plurality of illumination lists associated with routes (or paths) through which the users move from one spot (or one office) to another spot (or another office) in the building, to match the searched illumination lists to user IDs of the users, and to register the matched illumination lists and user IDs in the user access DB 34.

In at least one embodiment, the building management server 30 can control illumination in at least one remote building. That is, the building control unit 31 is configured to control one or more lights in the remote building that is not equipped with an automatic illumination control system. To achieve this, the building management server 30 needs to be connected to the ID recognition unit 20 or the mid-level lighting control unit 50 of the remote building through a wired or wireless communication means.

The building control unit 31 for controlling the remote building is configured to receive data about an entry into or exit from the remote building of occupants of the remote building through the ID recognition unit 20 of the remote building. The ID recognition unit 20 is configured to recognize a user ID of a person who enters into or exits from the remote building and to transmit data corresponding to the recognized user ID to the building management server 30.

The building control unit 31 is configured to control the mid-level lighting control unit 50 of the remote building to manage all or some of the lights in the remote building.

The building control unit 31 is configured to transmit a signal for controlling one or more lights to the mid-level lighting control unit 50 of the remote building. The mid-level lighting control unit 50 may perform a lighting switching function at the control request of the building management server 30 to turn on or off lights associated with the user ID recognized through the ID recognition unit 20, from among the plurality of lights.

The building control unit 31 is configured to check user information, outputted by the access information management unit 32, corresponding to the user ID (or each user ID of the users) recognized through the ID recognition unit 20, to determine whether the user (or each user) corresponding to the user ID (or each user ID of the users) enters into the building. When the user (or users) enters into the building, the building control unit 31 is configure to search an illumination list associated with the user ID (or each user ID of the users), and to instruct (or command) the mid-level lighting control unit 50 to control all or some of lights included in the searched illumination list to be turned on.

Upon determining that the user corresponding to the user ID otherwise exits from the building, the building control unit 31 is configured to search the illumination list associated with the user ID, to check whether the illumination list includes at least one light included in another illumination list associated with another user ID corresponding to another user who is currently in the building, and control all or some of lights in the illumination list by instructing (or commanding) the mid-level lighting control unit 50 to control one or more remaining lights other than the at least one light included in the another illumination list associated with the another user ID to be turned off.

If the illumination list does not include at least one light included in the another illumination list associated with the another user ID, the building control unit 31 controls one or more lights in the building by instructing the mid-level lighting control unit 50 to control all the lights (or some of the lights) included in the illumination list to be turned off.

The lighting setting interface 37 may be configured to be provided with the screen for setting an illumination list from the lighting setting unit 60 and to display the screen in order to set an illumination list at the request of a user (or users). The lighting setting interface 37 may execute the function thereof under the control of the building control unit 31.

As described above, the building management server 30 can store data such as user IDs of a plurality of buildings, illumination lists matched to user IDs, a lighting circuit for each building, etc. and automatical control lights.

Furthermore, the building control unit 31 according to at least one embodiment of this disclosure is configured to calculate the number of people staying inside the building on the basis of user IDs checked through the ID recognition unit 20 and store the calculated number of people currently staying in the building. Alternatively, the building control unit 31 can recognize people inside the building and calculate the number of people by interworking with a so-called building heating ventilation and cooling system installed in the building. The number of people in the building, recognized as above, may be used to check and alert people inside the building at the event of fire outbreaks or crime occurrence, for example.

Moreover, the building control unit 31 is configured to check (or determine) whether a user (or users) requests an illumination list, to display the screen for selecting lights through the lighting setting interface 37 when the user (or users) requests the illumination list, to receive the illumination list input by the user (or users), to confirm (or analyzes and finally determines) whether the number of lights included in the illumination list exceeds a predetermined number, and to finally set the illumination list if the number of lights included in the illumination list does not exceed the predetermined number. If the number of lights included in the illumination list exceeds the predetermined number, the building control unit 31 outputs a warning message.

The building control unit 31 is configured to calculate power consumption of each light, to store power rates corresponding to the calculated power consumption for each floor of the building and to display the power rates through the lighting setting interface 37.

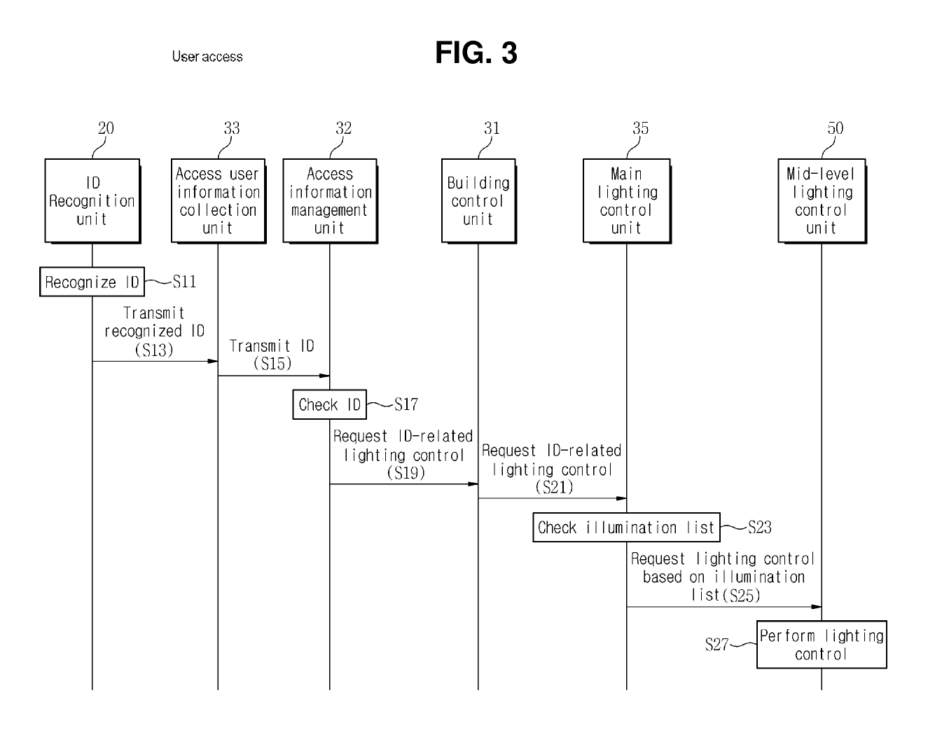

FIG. 3 is a flowchart of a method for automatically controlling illumination in a building in accordance with at least one embodiment.

Referring to FIG. 3, in the method for automatically controlling illumination in a building, the ID recognition unit 20 recognizes a user ID (or each user ID of a plurality of users) in step S11. The ID recognition unit 20 can recognize the user ID through a recognition means such as RF card recognition, fingerprint recognition, iris recognition and number recognition using a keypad.

Upon recognition of the user ID, the ID recognition unit 20 transmits information about the recognized user ID to the user access information collection unit 33 in step S13. The user access information collection unit 33 transmits the received information about the user ID to the access information management unit 32 in step S15.

Upon receipt of the information about the user ID, the access information management unit 32 checks the user ID in step S17. Here, the access information management unit 32 searches the user access DB 34 for data corresponding to the user ID and confirms (or analyzes and finally determines) an illumination data associated with the searched data.

The access information management unit 32 transmits the illumination list associated with the user ID to the building control unit 31 to request lighting control in step S19. The building control unit 31 delivers the received illumination list associated with the user ID to the main lighting control unit 35 in step S21.

The main lighting control unit 35 checks the received illumination list in step S23. Here, the main lighting control unit 35 can check (or search) the lighting circuit DB 36 to detect locations of lights associated with the user ID. Then, the main lighting control unit 35 requests lighting control to the mid-level lighting control unit 50 in order to control lights included in the illumination list in step S25. The mid-level lighting control unit 50, acting as switches, controls corresponding lights included in the illumination list to be turned on or off.

The mid-level lighting control unit 50 controls corresponding lights to be turned on or off according to the received lighting control signal at the lighting control request from the main lighting control unit 35 in step S27.

The building management server 30 can control illumination of a remote building. That is, the building management server 30 can control a remote building that is not equipped with an automatic illumination control system to control illumination in the remote building. Specifically, the building management server 30 may check whether a recognized user ID (or one or more recognized user IDs) corresponds to a user (or users) belonging to the remote building and control illumination of the remote building if the user ID corresponds to the user of the remote building. In this case, the building management server 30 checks whether the user enters the remote building, searches an illumination list in association with the user ID if the user enters the remote building, and transmits a signal for controlling all or some of the lights included in the searched illumination list to the mid-level lighting control unit 50 to turn all or some of the lights on or off. If the user corresponding to the checked user ID exits the remote building, the building management server 30 searches the illumination list in association with the user ID, checks (or determines) whether the illumination list includes at least one light included in another illumination list associated with another user. And if the illumination list includes the least one light included in the another illumination according to the determination, the building management server 30 transmits to the mid-level lighting control unit 50 a signal for controlling one or more remaining lights other than the at least one light included in the another illumination list associated with the another user to turn off.

In addition, the building management server 30 may calculate the number of people currently staying inside the building on the basis of user IDs to thereby check how may people is currently staying in the building, and store the calculated number at a memory or a storage equipped therewith or separately therefrom. Alternatively, the building management server 30 may check (or recognize and calculate) the number of people in the building by interworking with a so-called building heating ventilation and cooling system installed in the building. The number of people inside the building may be also used to check people existing in the building at the event of fire outbreaks or crime occurrence in the building.

Accordingly, all or some of lights in a building as well as remote buildings can be controlled to be tuned on/off by adaptively considering each recognized user ID of users entering to or exit from a building or a remote building regardless of whether or not people are inside a building, such that it is expected to reduce energy waste resulting from lighting of vacant space, to reduce the costs of changing lighting lamps, and to reduce the costs of energy for illumination. Furthermore, according to the various embodiments of this disclosure it can expect to get rid of the inconvenience of turning lights on/off using switches for a user and automatically turn lights on/off according to entry and exit information for people inside a building, thereby enhancing user convenience. In addition, it is possible to check how many people exist inside a building in real time, provide information about illumination energy consumption for each floor and each section of a building in real time to offer a power rate charging scheme in response to energy consumption, and thereby voluntarily reduce energy consumption in the building.

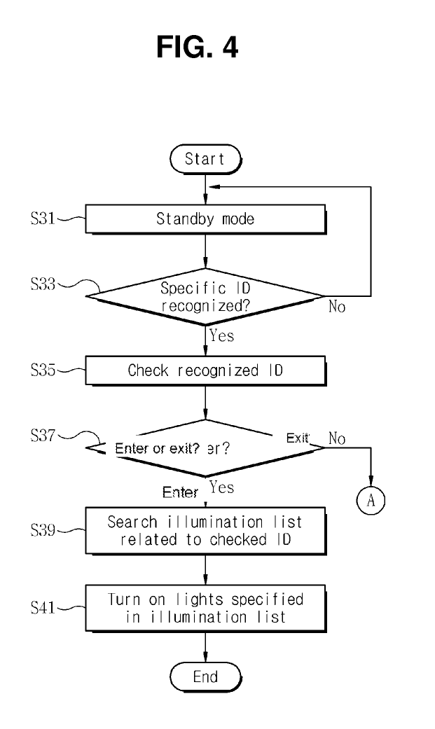

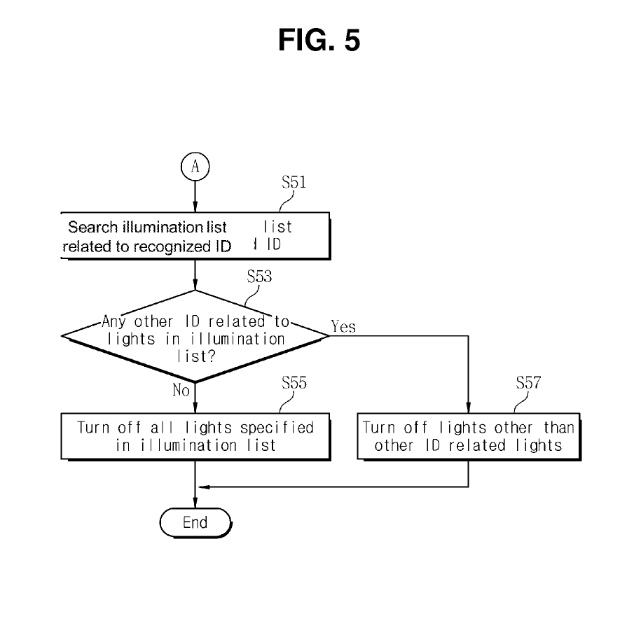

FIGS. 4 and 5 are flowcharts of a method for automatically controlling illumination in a building in accordance with at least one embodiment.

Referring to FIGS. 4 and 5, in the method of automatically controlling illumination in a building according to at least one embodiment, the building management server 30 is in a standby mode in step S31. Before being in the standby mode, the building management server 30 may check locations of offices (rooms, spaces, floors, sections and so on) in a building corresponding to a plurality of users staying in the building by detecting user IDs entering into or exit from the building, search a plurality of illumination lists associated with routes (or paths) through which the users move to or from the offices, match the searched illumination lists to user IDs and register the matched illumination list and user IDs.

The building management server 30 in the standby mode is configured to check (or detect) whether a specific user ID is recognized in step S33. Here, the building management server 30 can confirm (or analyze and/or determine) user information about the location(s) of an office(s) and a user name (or each user name) corresponding to the recognized user ID (or the recognized user IDs) in step S35. The building management server 30 recognizes the user ID (or each of the user IDs) through a recognition means such as RF card recognition, fingerprint recognition, iris recognition and number recognition using a keypad.

The building management server 30 detects whether the user (or each user) corresponding to the checked user ID (each of the checked user IDs) enters into or exit from the building in step S37. According to step S37, when the user enters into the building, the building management server 30 searches an illumination list (or each corresponding illumination list) associated with the recognized user ID (or each of the checked user IDs) in step S39. Then, the building management server 30 transmits a signal for controlling one or more lights included in the searched illumination list to the mid-level lighting control unit 50 to turn all or some of the lights on in step S41.

On the other hand, the user (or each user) corresponding to the user ID (each user ID) is detected to exit from the building in step S37, the building management server 30 searches then illumination list associated with the user ID (or each of the user IDs) in step S51. The building management server 30 checks (or determines) whether the searched illumination list includes at least one light included in another illumination list associated together with another user ID corresponding to another user who is currently in the building in step S53. If the illumination list includes the at least one light included in the another illumination list associated with the another user ID, the building management server 30 transmits a signal for controlling one or more remaining lights other than the at least one light included in the another illumination list associated together with the another user ID to the mid-level lighting control unit 50 to turn off in step S55. When the illumination list does not include the at least one light included in the another illumination list associated with the another user ID, the building management server 30 transmits to the mid-level lighting control unit 50 a signal for controlling all the lights (or some of the lights) included in the illumination list to turn off.

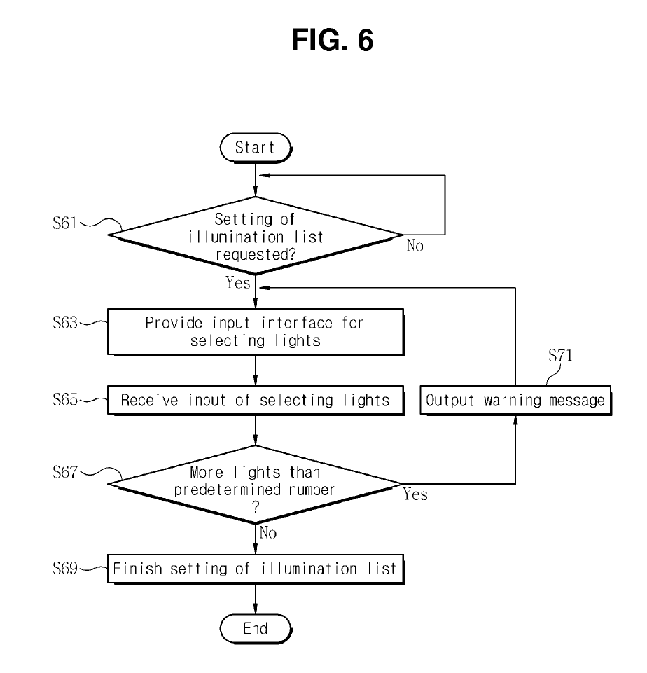

FIG. 6 is a flowchart of a method for automatically controlling illumination when a user moves in accordance with at least one embodiment.

Referring to FIG. 6, in the method for automatically controlling illumination when a user (or users) moves, the building management server 30 checks whether a user (or users) requests an illumination list while lights associated with a user ID of the user (or each user ID of the users) are turned on, in step S61. Alternatively, the user (each user of the users) may directly communicate with the building management server 30 through a web server for data transmission/reception in order to re-set (or register or establish) the illumination list according to the user's location change or user's route (or path). That is, the building management server 30 is configured to manage illumination lists even when many people in the building move simultaneously or sequentially, by allowing the user (each of the users) to directly re-set the illumination list associated with the user (or each user) itself.

When the user (or each of the users) requests the illumination list, the building management server 30 is configured to provide the screen for selecting a plurality of lights in step S63. The building management server 30 is configured to detect an input signal for selecting the illumination list requested by the user (or each of the users) in step S65. Then, the building management server 30 can receive and confirm (or analyze or determine) the illumination list input by the user (or each of the users).

The building management server 30 is configured to check (or determine or analyze) whether the number of lights included in the illumination list exceeds a predetermined number in step S67. If the number of lights included in the illumination list does not exceed the predetermined number, the building management server 30 sets the illumination list in step S69. The building management server 30 can turn on all or some of the lights corresponding to the set illumination list. That is, the building management server 30 may be configured to limit the authority to re-set the illumination list because the user (each of the users) directly sets the illumination list as much as needed when he moves. Accordingly, the building management server 30 is configured to control all or some of lights turned on in a wide range in the building.

If the number of lights included in the illumination list exceeds the predetermined number, the building management server 30 is configured to generate a warning message in step S71 and provide a screen for re-setting the illumination list. The warning message may represent that the number of lights included in the illumination list exceeds the predetermined number.

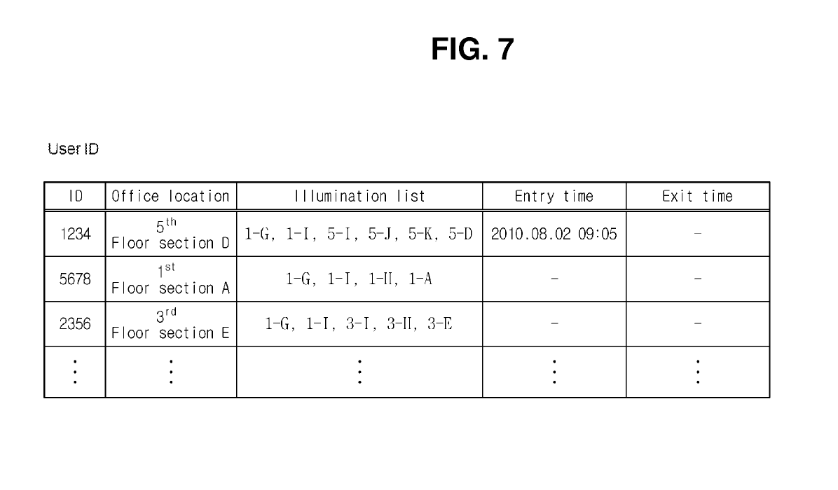

FIG. 7 a table of user information on entry into or exit from a building in accordance with at least one embodiment.

Referring to FIG. 7, user information stored in the user access DB 34 of the building management server 30 may include user IDs, locations of offices, illumination lists, and data corresponding to entry time and exit time. Each user ID may be updated for each entry into or exit from a building. For example, the illumination list is data about illumination necessary for a user (each of users) to move from an entrance of the building to his office and may be data for controlling lighting when the user (each of the users) enters into or exits from the building. Here, the user access DB 34 may is configured to store user information about occupants of the building. For example of user ID “1234” in FIG. 7, the user assigned as user ID 1234 is detected (or checked) in 5^{th} Floor section D by the management server 30. Illumination list of user ID 1234 as shown on the table of FIG. & includes at least one lights such as 1-G, 1-I, 5-I, 5-J, 5-K, and 5-D. Entry time (i.e., entrance time to enter into a building) of user ID 1234 indicates “2010. 08. 02 09:05.” Further, the user of user ID 1234 is detected to still stay in the building, because Exit time corresponding to user ID 1234 has not been detected and recorded on the table, yet. Accordingly, when he moves along his route in office location (e.g., 5^{th} Floor section D), all or some of lights associated with the illumination list of user ID 1234 may be controlled by the management server 30 to be turned all or some of the lights on/off.

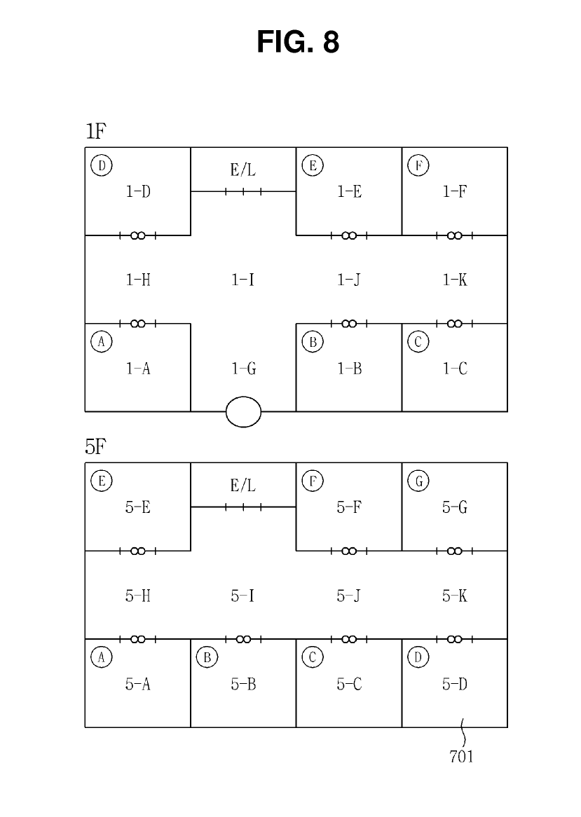

FIG. 8 a view of a lighting circuit in accordance with at least one embodiment.

Referring to FIG. 8, locations of lights, stored in the lighting circuit DB 36 of the building management server 30 include data about an illumination list corresponding to each floor of the building. For example, if a user is now detected to be in the location of an office corresponding to section D 701 on the fifth floor of a building, the building management server 30 is configured to transmit a signal for controlling lights corresponding to 1-G and 1-I installed onto the way from an entrance gate to an elevator on the first floor, and 5-I, 5-J, 5-K and 5-D, which are installed from an elevator to the user's office (i.e., section D 701) to be turned on to the mid-level lighting control unit 50 to turn all or some of the lights on/off upon determining that the user enters the building by checking the user ID. Conversely, the building management server 30 is configured to control all or some of the lights corresponding to 1-G, 1-I, 5-1, 5-J, 5-K and 5-D to be entirely or partially turned off upon determining that the user exits the building by checking the user ID. In this case, the building management server 30 checks whether the illumination list corresponding to the user (or each of the users) includes at least one light associated with an illumination list of another user and, if the at least one light associated with the illumination list of the another user is not present, transmits a signal for controlling all the lights included in the illumination list corresponding to the user (or each of the users) to the mid-level lighting control unit 50 to turn the lights off. On the other hand, if the illumination list corresponding to the user (each of the users) includes the at least one light associated with the illumination list of the another user, the building management server 30 is configured to transmit a signal for controlling the rest of lights other than the at least one light associated with the another user to the mid-level lighting control unit 50 to entirely or partially turn the corresponding lights off.

In various embodiments as discussed above, all or some of lights can be entirely or partially tuned on/off regardless of whether or not people are inside a building, thereby reducing energy waste resulting from lighting of vacant space, reducing the costs of changing lighting lamps, and reducing the costs of energy for illumination.

Furthermore, various embodiments as discussed above can reduce the inconvenience subject to turning lights on/off using switches for a user and automatically turn lights on/off according to entry and exit information for people inside a building, thereby enhancing user convenience.

In addition, it is possible to detect or check the number of people inside a building in real time, provide information about illumination energy consumption for each floor and each section in real time to offer a power rate charging scheme in response to energy consumption, thereby inducing a user (each of users) in the building to voluntarily reduce energy consumption.

The various embodiments as described above may be implemented in the form of one or more programs being readable through a variety of computer means and be recorded in any non-transitory, computer-readable medium. Here, this medium may contain, alone or in combination, program instructions, data files, data structures, and the like. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions may include machine language codes made by a complier and high-level language codes executable in a computer using an interpreter or the like. In some embodiments, one or more of the processes or functionality described herein is/are performed by specifically configured hardware (e.g., by one or more application specific integrated circuits or ASIC(s)). Some embodiments incorporate more than one of the described processes in a single ASIC. In some embodiments, one or more of the processes or functionality described herein is/are performed by at least one processor which is programmed for performing such processes or functionality.

While various embodiments have been particularly shown and described, it will be understood by those skilled in the art that various changes in form and details may be made therein without departing from the subject matter and scope of this disclosure. Specific terms used in this disclosure and drawings are used for illustrative purposes and not to be considered as limitations of the present disclosure.

What is claimed is:

1. A building management server, comprising:
an access information management unit configured to recognize at least one user ID and to output user information corresponding to the recognized at least one user ID; and
a building control unit configured to
check the user information outputted by the access information management unit to detect an entry or exit of a user corresponding to the at least one user ID into or form a building,
check an illumination list in association with the at least one user ID according to the detected entry or exit, and
control one or more lights in the illumination list.

2. The management server of claim 1, wherein the building control unit is configured to
determine, when an exit of the user is detected, whether the illumination list includes at least one light included in another illumination list associated with another user ID corresponding to another user who is currently in the building, and
control one or more remaining lights in the illumination list other than the at least one light included in the another illumination list, according to the determination.

3. The building management server of claim 1, wherein the access information management unit is configured to recognize the user ID through at least one selected from the group consisting of RF card recognition, fingerprint recognition, and iris recognition.

4. The building management server of claim 2, wherein the building control unit is configured to control all of the one or more the lights included in the illumination list to be turned off upon determining that the illumination list does not include the at least one light included in the another illumination list associated with the another user ID.

5. The building management server of claim 1, wherein the building control unit is configured to check locations of offices corresponding to one or more users, to search a lighting circuit DB for one or more illumination lists associated with routes through which the users move to or from the corresponding offices, to match the searched illumination lists to user Ds of the users, and to register the matched illumination lists and corresponding user IDs in an entry and exit DB.

6. The building management server of claim 1, further comprising:
main lighting control unit configured to manage one or more lights in the building upon receiving a request from the building control unit.

7. The building management server of claim 1, wherein the building control unit is configured to calculate the number of people inside the building through the user information, to store and to display the calculated number.

8. The building management server of claim 1, wherein the building control unit is configured to determine whether a user requests an illumination list, to provide a screen for selecting a plurality of lights when the user requests the illumination list, to receive the illumination list input by the user, to check whether the number of lights included in the illumination list exceeds a predetermined number, and to set the illumination list if the number of lights included in the illumination list does not exceed the predetermined number.

9. The building management server of claim 8, wherein the building control unit is configured to check the illumination list input by the user and to generate a warning message if the number of lights included in the illumination list exceeds the predetermined number.

10. The building management server of claim 1, wherein the building control unit is configured to calculate power consumption of each light, to store a power rate corresponding to the calculated power consumption for each floor of the building, and to display the power rate for the corresponding floor in real time.

11. A method performed by a building management server for automatically controlling illumination, the method comprising:
recognizing at least one user ID;
outputting user information corresponding to the recognized at least one user ID;
checking the outputted user information to detecting an entry into or exit of a user corresponding to the at least one user ID into or from a building;
checking an illumination list association with the at least user ID according to the detected entry or exit; and
controlling one or more lights in the illumination list.

12. The method of claim 11, further comprising:
determining, when an exit of the user is detected, whether the illumination list includes at least one light included in another illumination list associated with another user ID corresponding to another user who is currently in the building; and
controlling one or more remaining lights other than the at least one light included in the another illumination list to be turned off or on.

13. The method of claim 11, wherein the step of recognizing the at least one user ID comprises
recognizing the at least one user ID through at least one selected from the group consisting of RF card recognition, fingerprint recognition, and iris recognition.

14. The method of claim 12, wherein the step of the controlling comprises controlling all or some of the lights included in the illumination list to be turned off upon determining that the illumination list does not include the at least one light included in the another illumination list.

15. The method of claim 11, further comprising:
checking locations of offices of the at least one user;
searching at least one illumination list associated with route through which the at least one user moves to or from the corresponding offices; and
matching the searched at least one illumination list to the at least one user ID of the at least one user and registering the matched at least one illumination list and corresponding user ID.

16. The method of claim 11, wherein the step of recognizing the at least one user ID comprises:
checking whether the at least one user ID corresponds to at least one user ID corresponding to at least one user of a remote building; and
controlling illumination of the remote building if the least one user ID corresponds to the least one user ID of the least one user of the remote building.

17. The method of claim 16, wherein the step of controlling illumination of the remote building comprises:
detecting an entry into or exit from the remote building of at least one user corresponding to the recognized at least one user ID;
searching an illumination list in association with the at least one user ID according to the entry into the remote building; and
controlling one or more lights included in the illumination list to be turned on or off.

18. The method of claim 11, further comprising:
calculating the number of people inside the building through the recognized at least one user ID; and
storing and displaying the calculated number.

19. The method of claim 11, further comprising:
determining whether a user requests an illumination list;
providing a screen for selecting a plurality of lights when the user requests the illumination list;
receiving the illumination list input by the user;
checking whether the number of lights included in the illumination list exceeds a predetermined number; and
setting the illumination list if the number of lights included in the illumination list does not exceed the predetermined number.

20. The method of claim 11, further comprising:
generating a warning message if the number of lights included in the illumination list exceeds the predetermined number;
calculating power consumption of each light; and
storing power rates corresponding to the calculated power consumption for each floor and displaying the power rates in real time.
